(19) United States
(12) Patent Application Publication
(10) Pub. No.: US 2019/0071535 A1
(43) Pub. Date: Mar. 7, 2019

(54) CROSSLINKED POLYURETHANE

(71) Applicant: BASF SE, Ludwigshafen (DE)

(72) Inventors: Elmar Poeselt, Lemfoerde (DE); Johannes Poppenberg, Wyandotte, WI (US); Berend Eling, Lemfoerde (DE); Fritz Nimtz, Ludwigshafen (DE); Irina Fink, Hamburg (DE)

(21) Appl. No.: 16/086,667

(22) PCT Filed: Mar. 17, 2017
(86) PCT No.: PCT/EP2017/056333

§ 371 Date: Sep. 20, 2018

(30) Foreign Application Priority Data
Mar. 21, 2016 (EP) 16161310.4
Mar. 13, 2017 (EP) 17160616.3

(51) Int. Cl. C08G 18/69; C08G 18/76; C08G 18/32; C08G 18/82; C08G 18/86; C08G 18/87; C08J 3/24

(52) U.S. Cl. CPC C08G 18/694; C08G 18/7671; C08G 18/3206; C08G 18/82; C08J 2421/00; C08G 18/87; C08J 3/24; C08J 2375/14; C08G 18/86

(57) ABSTRACT

A crosslinked polyurethane obtainable by a process is disclosed wherein polyisocyanates are mixed with polymeric compounds having at least two hydrogen atoms reactive toward isocyanate groups and comprising at least one diene block copolymer which has at least two hydrogen atoms reactive toward isocyanate and has a polydiene main chain and at least one side chain or terminal chain composed of a polyether and/or a polyester, where the proportion by weight of the polydiene main chain is, based on the total weight of the diene block copolymer, from 25 to 95% by weight, to give a reaction mixture that is cured. Composites and blends composed of crosslinked polyurethane and rubber are also disclosed, as well as the use of crosslinked polyurethane in the production of tires or parts of tires, cable sheathing, shoe sole, roller or hose.

The present invention relates to a crosslinked polyurethane obtainable by a process wherein (a) polyisocyanates are mixed with (b) polymeric compounds having on average at least 1.5 hydrogen atoms which are reactive toward isocyanate groups and comprising (b1) at least one diene block copolymer which has on average at least 1.5 hydrogen atoms which are reactive toward isocyanate and has a polydiene main chain and at least one side chain or terminal chain composed of a polyether and/or a polyester, where the proportion by weight of the polydiene main chain is, based on the total weight of the diene block copolymer b1), from 25 to 95% by weight, and optionally (b2) further polymeric compounds having on average at least 1.5 hydrogen atoms which are reactive toward isocyanate, optionally (c) catalyst, optionally (d) vulcanizing agents, optionally (e) chain extenders and/or crosslinkers, optionally (f) blowing agent and optionally (g) auxiliaries and/or additives to give a reaction mixture, the mixture is cured to give crosslinkable polyurethane and double bonds of the diene block copolymer (b1) are crosslinked. The present invention further relates to composites and blends composed of crosslinked polyurethane and rubber and also the use of crosslinked polyurethane as tires or parts of tires, as cable sheathing, shoe sole, roller or hose.

Elastomers produced from rubber are used in a variety of fields of application, for example in the production of tires for vehicles, for producing shoe soles, for producing rollers, for example in industrial plants, or for producing mats, seals, gloves or cable sheathing.

For use in such and similar applications, it is likewise possible to use polyurethane. However, it has been found in this case that the strengths of rubber and polyurethane are in different ranges. Thus, rubber displays a high wet skid resistance, allows a low rolling resistance of tires and low abrasion. On the other hand, the strengths of polyurethane are, in particular, a relatively high modulus and a relatively high hardness. Furthermore, polyurethane is very stable chemically, for example in the presence of solvents.

It would therefore be desirable to combine the advantageous properties of rubber and polyurethane. This is made possible by using composite materials composed of rubber and polyurethane. A problem here is the limited adhesion of the two materials.

Furthermore, efforts are being made to match the properties of polyurethane to those of rubber. U.S. Pat. No. 4,104,265 thus proposes functionalizing polybutadiene with hydroxyl groups, admixing it with sulfur-containing vulcanizing agents and reacting it with polyisocyanate in a first step at temperatures below 120° C. to give an uncrosslinked polyurethane and subsequently vulcanizing the latter by heating to from 145 to 200° C. U.S. Pat. No. 4,104,265 proposes using this material in the production of tires, for example as side wall or as tread of tires. Disadvantages are the poor compatibility with the further components for producing the polyurethanes and the resulting poor mechanical properties of the crosslinked polyurethane obtained. This is reflected, for example, in an only unsatisfactory reaction of the polyols with the isocyanate and as a result only an unsatisfactory molecular weight buildup. However, particularly in the case of thermoplastic polyurethane, complete reaction of the starting compounds is essential because of the lack of chemical crosslinking.

To improve the compatibility, EP 1710263 proposes producing an isocyanate prepolymer from compounds comprising isocyanate groups and polydienols and then converting this into the polyurethane, but the mechanical properties are still capable of improvement.

WO 2007025690 describes a vulcanizable mixture composed of a rubber polymer and a diene-based thermoplastic polyurethane. The mechanical properties of these materials are also capable of improvement.

It was an object of the present invention to provide materials which combine the properties of rubber and polyurethane and in that case display excellent properties such as high wet skid resistance, low rolling resistance, low abrasion, high modulus and also good haptic properties. Furthermore, it was an object of the present invention to provide composite materials composed of polyurethane and rubber which display excellent adhesion and can be used, for example, in the production of tires.

This object is achieved by a process for producing a crosslinked polyurethane, wherein (a) polyisocyanates are mixed with (b) polymeric compounds having on average at least 1.5 hydrogen atoms which are reactive toward isocyanate groups and comprising (b1) at least one diene block copolymer which has on average at least 1.5 hydrogen atoms which are reactive toward isocyanate and has a polydiene main chain and at least one side chain or terminal chain composed of a polyether and/or a polyester, where the proportion by weight of the polydiene main chain is, based on the total weight of the diene block copolymer b1), from 25 to 95% by weight, and optionally (b2) further polymeric compounds having on average at least 1.5 hydrogen atoms which are reactive toward isocyanate, optionally (c) catalyst, optionally (d) vulcanizing agents, optionally (e) chain extenders and/or crosslinkers, optionally (f) blowing agent and optionally (g) auxiliaries and/or additives to give a reaction mixture, the mixture is cured to give crosslinkable polyurethane and double bonds of the diene block copolymer (b1) are crosslinked. This object is additionally achieved by composites and blends composed of crosslinked polyurethane and rubber and also the use of crosslinked polyurethane as tires or parts of tires, as cable sheathing, shoe sole, roller or hose.

For the purposes of the present invention, the mixture of the components a) and b) and optionally c) to g) at reaction conversions of less than 90%, based on the isocyanate groups, will be referred to as reaction mixture. Furthermore, a crosslinked polyurethane is, for the purposes of the invention, understood to be a polyurethane obtained by crosslinking of double bonds in the crosslinkable polyurethane. Preference is given here to at least 2%, particularly preferably at least 10% and in particular at least 15%, of the double bonds originally comprised being crosslinked. Such a crosslinked polyurethane can be produced by the process of the invention as per claim 1. For the purposes of the present invention, a crosslinkable polyurethane is understood to be a polyurethane which comprises double bonds, with there being the practical possibility of crosslinking these double bonds so as to give crosslinked polyurethane.

A crosslinked polyurethane is essentially distinguished by its solubility behavior in dimethylformamide at 40° C. Here, crosslinking leads to a significant impairment of the dissolution and swelling behavior. For this purpose, the dissolution/swelling behavior of a crosslinkable polyurethane sample is firstly determined. For this purpose, a sample of the material having dimensions of 0.5 cm×1 cm×2 cm is weighed and stored in 100 ml of dimethylformamide at 40° C. for 24 hours. The sample is subsequently taken out, excess solvent is blotted off and the mass of the swollen sample is determined. The solvent is also evaporated and the mass of the dissolved polymer is determined. If more than 30% by weight of the initial weight of the crosslinkable polymer have been dissolved, crosslinking of the crosslinked polyurethane is determined from the proportion of soluble material. Here, a crosslinked polyurethane is, for the purposes of the invention, present when the proportion of dissolved sample constituents decreases by preferably at least 10% by weight, particularly preferably at least 30% by weight and in particular at least 50% by weight, based on the total weight of the dissolved fraction of the sample of the crosslinkable polyurethane.

At 30% by weight and below of crosslinkable polyurethane in solution, crosslinking is determined from the swelling. Here, a crosslinked polyurethane is, for the purposes of the invention, present when the proportion of solvent in the swollen sample, which can be determined by means of the weight difference before and after the swelling experiment, decreases by preferably at least 10% by weight, particularly preferably at least 15% by weight and in particular by at least 20% by weight.

The crosslinking of the double bonds of the crosslinkable polyurethane according to the present invention can be effected here by means of conventional, chemical vulcanizing agents such as sulfur-comprising vulcanizing agent or vulcanizing agent comprising free-radical initiators such as peroxides or AIBN. Furthermore, crosslinking can also be effected by irradiation with high-energy radiation, for example UV light, electron beams or β- or γ-radiation. A further possible crosslinking method is thermal crosslinking at temperatures above 150° C. in the presence of oxygen. For this reason, a polyurethane which comprises double bonds but no chemical crosslinker (d) will also be referred to as crosslinkable polyurethane for the purposes of the present invention. Preferably, the crosslinking according to the invention is performed by way of chemical crosslinking agents or by irradiation with high-energy radiation, more preferably by chemical crosslinking agents and in particular by sulfur-comprising vulcanizing agent.

If crosslinking is carried out by means of conventional, chemical vulcanizing agents, the vulcanizing agent can be initially present in the reaction mixture for producing the crosslinkable polyurethane. In this case, crosslinking can also be initiated by the evolution of heat in polyurethane production. This can, for example, be useful in the production of pourable elastomers and especially of composites of pourable elastomers with rubber. This has the advantage that only one reaction step is necessary for producing the crosslinked polyurethane. Furthermore, particularly good adhesion between rubber and crosslinked polyurethane is ensured in the production of composite elements. This can be improved further by covulcanization in which rubber and crosslinkable polyurethane are crosslinked in one step. Here, the reaction mixture for producing the polyurethane is added to a rubber mixture comprising vulcanization mixture and the vulcanization of the crosslinkable polyurethane and of the rubber mixture is started. The vulcanization can optionally also be carried out in a heated press or mold.

As an alternative, care can be taken to ensure that the vulcanization does not commence during reaction of the reaction mixture to form the crosslinkable polyurethane. This can, for example, be effected by temperature control in a mold. The vulcanization, for example in the production of composite bodies, can then be effected under conventional vulcanization conditions independently of the production of the crosslinkable polyurethane. An example of this is a hot melt adhesive having improved adhesion to rubber, with the starting materials for producing the crosslinkable polyurethane being selected so that a fusable adhesive comprising thermally activatable vulcanizing agent is formed. Crosslinking is initiated by melting at temperatures above 140° C.

Furthermore, in the case of a thermoplastically processable polyurethane, the vulcanizing agent (d) can be introduced after production of the crosslinkable polyurethane. This can be carried out, for example, by extrusion, for example in a twin-screw extruder. Here, it has to be ensured that the extrusion temperature is below the start temperature of crosslinking. Furthermore, the vulcanizing agent can also be effected by inward diffusion, for example by swelling of the crosslinkable polyurethane in a solvent comprising a chemical vulcanizing agent.

In a further embodiment, extrusion is carried out at a temperature at which crosslinking commences but is complete only after final shaping of the crosslinked polyurethane. In this way, it is possible, for example, to extrude a hose or cable sheathing which subsequently crosslink automatically.

Crosslinkable polyurethane according to the present invention can also comprise one or more further polymers, preferably in the form of a blend. The further polymer is preferably a rubber. For example, such a blend can be obtained by extrusion of a crosslinkable polymer and of the further polymer or by dissolution of the further polymer in one of the components a) to h). The further polymer is preferably one or more polymers selected from among rubbers. The proportion of the further polymers, based on the total weight of the components a) to h), is preferably up to 100% by weight, and preferably from 10 to 50% by weight. In a further preferred embodiment of the present invention, the crosslinkable polyurethane does not comprise any further polymers. Crosslinking of the rubber preferably also occurs during crosslinking of the crosslinkable polyurethane, so that a crosslinked blend having chemical bonds between molecules of the polyurethane and of the rubber is obtained. The type of crosslinking positions can be controlled by targeted selection and combination of the vulcanization accelerators and the amount of sulfur.

For the purposes of the present invention, the term rubber here encompasses plastically deformable elastomers such as, for example, butadiene rubber (BR), styrene-butadiene rubber (SBR), isoprene rubber (IR), styrene-isoprene-butadiene rubber (SIBR), acrylonitrile-butadiene rubber (NBR), chloroprene rubber (CR), isobutene-isoprene rubber (IIR), natural rubber (NR), which can be present either in pure form or in blends with one another. The elastomers in this case optionally comprise commercially available fillers such as carbon blacks, silica, chalk, metal oxides, plasticizers, antioxidants, ozone stabilizers and/or thermoplastic polymers such as styrene-comprising thermoplastics, for example polystyrene or polystyrene-acrylonitrile (SAN), ethylene-vinyl acetate (EVA), polyethylene, polypropylene, polycarbonate, thermoplastic polyurethane (TPU), polyvinyl chloride (PVC) or thermoplastic elastomers based on styrene-butadiene-styrene block copolymers or styrene-isoprene-styrene block copolymers or blends of the abovementioned thermoplastics with one another. Rubbers can further comprise conventional vulcanizing agents (d).

For the purposes of the present invention, the term rubber refers to crosslinked rubber mixtures. Here, the term crosslinked rubber refers to the pure elastomers or elastomer blends or elastomers or elastomer blends which can optionally comprise fillers, in particular thermoplastic polymers which have been mixed with vulcanization accelerators and/or crosslinkers, for example ones based on sulfur or peroxide, and vulcanized according to routine practice. Such rubber mixtures are described, for example, in P. A. Ciullo, “The rubber formulary”, Hoyes Publications, 1999, ISBN: 0-8155-1434-4. Rubber is particularly preferably vulcanized rubber comprising butadiene rubber (BR), styrene-butadiene rubber (SBR), isoprene rubber (IR), styrene-isoprene-butadiene rubber (SIBR), acrylonitrile-butadiene rubber (NBR), chloroprene rubber (CR), isobutene-isoprene rubber (IIR), and natural rubber (NR) or mixtures thereof which have been mixed with vulcanization accelerators and/or crosslinkers based on sulfur or peroxide and vulcanized according to routine practice. In particular, vulcanized acrylonitrile-butadiene rubber or styrene-butadiene rubber is used as rubber.

Here, all 2-functional or higher-functionality polyisocyanates known for polyurethane production can be used as polyisocyanate a). These comprise the aliphatic, cycloaliphatic and aromatic two-functional or polyfunctional isocyanates known from the prior art and also any mixtures thereof. Examples are diphenylmethane 4,4′-diisocyanate, diphenylmethane 2,4′-diisocyanate, mixtures of monomeric diphenylmethane diisocyanates and homologues of diphenylmethane diisocyanate having more than two rings (polymeric MDI), tetramethylene diisocyanate, hexamethylene diisocyanate (HDI), mixtures of hexamethylene diisocyanates and homologues of hexamethylene diisocyanate having more than two rings (multiring HDI), isophorone diisocyanate (IPDI), tolylene 2,4- or 2,6-diisocyanate (TDI), naphthylene diisocyanate (NDI) or mixtures of the isocyanates mentioned. Preference is given to using tolylene diisocyanate (TDI), diphenylmethane diisocyanate (MDI) and in particular mixtures of diphenylmethane diisocyanate and polyphenylenepolymethylene polyisocyanates (crude MDI). The isocyanates can also have been modified, for example by incorporation of uretdione, carbamate, isocyanurate, carbodiimide, allophanate and in particular urethane groups.

Particular preference is given to using symmetric isocyanates as polyisocyanates (a). Here, polyisocyanates are referred to as symmetric isocyanates when their structural formula has at least one mirror plane. Examples of such symmetric isocyanates are diphenylmethane 4,4′-diisocyanat, 4,4′-H12-MDI, hexamethylene diisocyanate, 2,6-TDI and naphthylene 1,5-diisocyanate (1,5-NDI).

Here, the isocyanate component A can also be used in the form of isocyanate prepolymers comprising isocyanate groups. These polyisocyanate prepolymers can be obtained by reacting an excess of polyisocyanates as described above as component A1 with compounds of the component (b) and/or (d), for example at temperatures of from 30 to 100° C., preferably about 80° C., to form the prepolymer. Preference is given here to using such mixing ratios that the isocyanate group content of the prepolymer (hereinafter also referred to as NCO content) is from 3 to 35% by weight, preferably from 4 to 30% by weight and in particular from 5 to 20% by weight.

To produce the prepolymers, 4,4′-MDI is preferably reacted with uretonimine-modified MDI and commercial polyols based on polyesters, for example derived from adipic acid, or polyethers, for example derived from ethylene oxide and/or propylene oxide.

Particular preference is given to using 4,4′-MDI as isocyanate.

The polymeric compounds (b) having on average at least 1.5 hydrogen atoms which are reactive toward isocyanate groups comprise at least one diene block copolymer b1) which has on average at least 1.5 hydrogen atoms which are reactive toward isocyanate and has a polydiene main chain and at least one side chain or terminal chain composed of a polyether and/or a polyester. Examples are alkylene oxide chains, ester chains and in particular ester groups which can be obtained by ring-opening of a cyclic ester such as ε-caprolactone, 1,6-dioxacyclododecane-7,12-dione (CAS777-95-7) and oxacyclodecan-2-one. Here, the proportion by weight of the polydiene chain, based on the total weight of the diene block copolymer b1), is from 25 to 95% by weight, preferably from 40 to 93 and particularly preferably from 50 to 90% by weight. The proportion by weight of the polyether and/or polyester chain is from 5 to 75% by weight, preferably from 7 to 60% by weight and in particular from 10 to 50% by weight. A polydiene main chain consists of, for example, polybutadiene, polyisoprene, copolymers of butadiene and isoprene or copolymers of butadiene and/or isoprene and further unsaturated monomers such as styrene. Here, the proportion of butadiene and/or isoprene in the polydiene main chain having further unsaturated monomers is at least 50% by weight, preferably at least 70% by weight and in particular at least 90% by weight. Polybutadiene is particularly preferably used as polydiene main chain. In a very particularly preferred embodiment, no further monomer units apart from the polydiene chain and the polyether and/or the polyester chain are comprised in the diene block copolymer b1).

Diene block copolymers b1) according to the invention preferably have a number average molecular weight of from 600 to 20 000 g/mol, particularly preferably from 750 to 10 000 g/mol and in particular from 1000 to 7500 g/mol. Here, the number of hydrogen atoms which are reactive toward isocyanate per molecule, preferably the hydroxyl functionality, is preferably from 1.5 to 5, particularly preferably from 2.0 to 3.5 and in particular from 2.0 to 3.0. Preference is given to at least 50%, particularly preferably at least 70 and in particular all, of the hydroxyl groups being primary hydroxyl groups. If thermoplastic processing of the crosslinkable polyurethane is to be carried out, it is necessary for the number of hydrogen atoms in the compound b1) which are reactive toward isocyanate to be on average from 1.5 to 2.2, preferably from 1.8 to 2.2, particularly preferably from 1.9 to 2.1 and in particular from 1.95 to 2.01.

The diene block copolymers b1) are obtained starting out from a diene polymer modified with hydroxyl groups. These are commercially available. Suitable polydienols, in particular polybutadienols, are prepared by controlled free-radical polymerization or by anionic polymerization or are hydroxyl-modified polybutadienes prepared starting out from liquid polybutadienes, for example from products obtainable under the tradename Lithene®, from Synthomer, Essex, UK.

Here, the diene polymer can have been prepared by, for example, anionic polymerization starting out from a bifunctional or polyfunctional starter, for example 1,4-dilithiobutane. The preparation of hydroxyl-terminated polybutadienes is described, for example, in DD 154609 and DD 159775.

Hydroxyl-modified polydienols can be prepared from unfunctionalized polydienol polymers, for example polybutadiene, having, in general, a number average molecular weight of from 500 to 15 000 g/mol, preferably from 750 to 10 000 g/mol, particularly preferably from 1000 to 7500 g/mol and in particular from 1000 to 2000 g/mol. One possibility is partial epoxidation of double bonds present and subsequent opening of these epoxides by means of suitable nucleophiles. The epoxidation of polydienes is described, for example, in Perera, Ind. Eng. Chem. Res. 1988, 27, 2196-2203. Epoxidized products can be obtained by reaction of polydiene polymers with percarboxylic acids. Here, the percarboxylic acid can be used directly or be generated in situ from the carboxylic acid and hydrogen peroxide. For example, formic acid as simplest carboxylic acid can be used for the epoxidation.

Epoxidized polydiene polymers can be converted by means of suitable nucleophiles such as water, alcohols or amines into hydroxyl-functionalized polydiene polymers. Alcohols such as ethanol and butanol are preferred. Suitable catalysts for this reaction are strong acids such as mineral acids, for example as described in EP 0585265 B1, boron trifluoride, for example as described in U.S. Pat. No. 5,242,989, or trifluoromethanesulfonic acid, for example as described in WO 96/20234 and also Li, J. Macromol. Sci, Part A, 2013, 50, 297-301.

In contrast to the hydroxyl-terminated diene polymers produced by anionic or free-radical polymerization, the post-functionalized polydiene polyols have hydroxyl groups not selectively as end groups but instead randomly distributed over the backbone of the polydiene polyols.

To produce the diene block copolymers b1) having at least two hydrogen atoms which are reactive toward isocyanate, the hydroxyl-functionalized polydiene polymers are reacted with alkylene oxides under alkoxylation conditions to form the ether block. Here, customary alkylene oxides, for example ethylene oxide or propylene oxide, can be reacted using a catalyst. As catalyst, it is possible to use customary basic catalysts such as potassium hydroxide or double metal cyanide catalysts. Polyester blocks can be obtained, for example, by reaction with aliphatic or aromatic dicarboxylic acids and polyhydric alcohols under esterification conditions.

The diene block copolymers (b1) preferably comprise end groups obtained by reaction with a cyclic ester. For this purpose, the polydiene polymers produced by anionic or free-radical polymerization or the post-functionalized polydiene polymers obtained by epoxidation are polyester-modified by ring-opening copolymerization with a cyclic ester, for example ε-caprolactone, 1,6-dioxacyclododecane-7,12-dione or oxacyclodecan-2-one, preferably ε-caprolactone, in the presence of a catalyst. Catalysts used are titanium catalysts such as titanium tetrabutoxide, as described in JP-A 60023418.

As further polymeric compounds (b2) having on average at least 1.5 hydrogen atoms which are reactive toward isocyanate, it is possible to use all known compounds having hydrogen atoms which are reactive toward isocyanates, for example those having an average functionality of from 2 to 8 and a number average molecular weight of from 400 to 15 000 g/mol. Thus, it is possible to use, for example, compounds selected from the group consisting of polyether polyols, polyester polyols and mixtures thereof.

Polyetherols are prepared, for example, from epoxides such as propylene oxide and/or ethylene oxide or from tetrahydrofuran using hydrogen-active starter compounds such as aliphatic alcohols, phenols, amines, carboxylic acids, water or compounds based on natural materials, e.g. sucrose, sorbitol or mannitol, using a catalyst. Here, mention may be made of basic catalysts or double metal cyanide catalysts, as described, for example, in PCT/EP2005/010124, EP 90444 or WO 05/090440.

Polyesterols are, for example, prepared from aliphatic or aromatic dicarboxylic acids and polyhydric alcohols, polythioether polyols, polyester amides, hydroxyl-comprising polyacetals and/or hydroxyl-comprising aliphatic polycarbonates, preferably in the presence of an esterification catalyst. Further possible polyols are indicated, for example, in “Kunststoffhandbuch, volume 7, Polyurethane”, Carl Hanser Verlag, 3^{rd} edition 1993, chapter 3.1. In a preferred embodiment, the polymeric compounds (b2) having on average at least 1.5 hydrogen atoms which are reactive toward isocyanate comprise polytetramethylene glycol (polyTHF) having an average molecular weight of preferably from 400 to 6000 g/mol, particularly preferably from 500 to 2500 g/mol and in particular from 800 to 2000 g/mol.

The proportion of polymeric compounds (b2) having at least two hydrogen atoms which are reactive toward isocyanate is, based on the total weight of the component b), preferably from 0 to 70% by weight, particularly preferably from 0 to 50% by weight and in particular from 0 to 40% by weight. In a very particularly preferred embodiment, no further polymeric compounds (b2) having at least two hydrogen atoms which are reactive toward isocyanate are used.

The determination of the molecular weight of the compounds of the component b) is carried out by determining the OH number.

As catalysts c), it is possible to use customary compounds which strongly accelerate the reaction of the polymeric compounds (b) having at least two hydrogen atoms which are reactive toward isocyanate groups and optionally chain extenders and crosslinkers (e) and chemical blowing agent (f) with the organic, optionally modified polyisocyanates (a).

Mention may be made by way of example of amidines such as 2,3-dimethyl-3,4,5,6-tetrahydropyrimidine, tertiary amines such as triethylamine, tributylamine, dimethylbenzylamine, N-methylmorpholine, N-ethylmorpholine, N-cyclohexylmorpholine, N,N,N′,N′-tetramethylethylenediamine, N,N,N′,N′-tetramethyl-butanediamine, N,N,N′,N′-tetramethylhexanediamine, pentamethyldiethylenetriamine, bis(dimethylaminoethyl) ether, bis(dimethylaminopropyl)urea, dimethylpiperazine, 1,2-dimethylimidazole, 1-azabicyclo[3.3.0]octane and preferably 1,4-diazabicyclo[2.2.2]-octane and alkanolamine compounds such as triethanolamine, triisopropanolamine, N-methyldiethanolamine and N-ethyldiethanolamine and dimethylethanolamine. Further possibilities are organic metal compounds, preferably organic tin compounds such as tin(II) salts of organic carboxylic acids, e.g. tin(II) acetate, tin(II) octoate, tin(II) ethylhexanoate and tin(II) laurate, and the dialkyltin(IV) salts of organic carboxylic acids, e.g. dibutyltin diacetate, dimethyltin dilaurate, dibutyltin dilaurate, dibutyltin maleate and dioctyltin diacetate, and also bismuth carboxylates such as bismuth(III) neodecanoate, bismuth 2-ethylhexanoate and bismuth octanoate, or mixtures thereof. The organic metal compounds can be used either alone or preferably in combination with strongly basic amines. When the component (b) is an ester, preference is given to using exclusively amine catalysts. In a particularly preferred embodiment, exclusively catalysts which can be built in are used as catalysts (c).

If catalysts (c) are used, these can, for example, be used in a concentration of from 0.001 to 5% by weight, in particular from 0.05 to 2% by weight, as catalyst or catalyst combination, based on the weight of the component (b).

As vulcanizing agents (d), use is made of conventional vulcanization packets, for example those based on sulfur or peroxides. Examples of sulfur-comprising vulcanizing agents are elemental sulfur or a sulfur-donating vulcanizing agent such as amine disulfide, polymeric polysulfide or sulfur-olefin adducts and also mixtures thereof. Here, the sulfur-based vulcanizing agent is used, for example, in amounts of from 0.5 to 6% by weight, preferably from 0.75 to 4.0% by weight, in each case based on the total weight of the components (a), (b), (c), (d) and (e). Peroxidic vulcanizing agent is used, for example, in amounts of from 0.01 to 20% by weight, preferably 0.05 to 10% by weight and particularly preferably 0.1 to 5% by weight, in each case based on the total weight of the components (a), (b), (c), (d) and (e).

As peroxide-comprising vulcanizing agents, it is possible to use alkoxy-based organic peroxides such as di-tert-butyl peroxide, dicumyl peroxide, 2,5-bis(tert-butylperoxy)-2,5-dimethylhexane, -bis(tert-butylperoxy)diisopropylbenzene, tert-butyl cumyl peroxide and 2,5-dimethyl-2,5-(di-tert-butylperoxy)-3-hexyne. Reactive coagents such as multifunctional acrylates or methacrylate esters, alicyclic compounds or bismaleimides are typically used in addition to the peroxides. Active peroxides are normally used in amounts of from 1 to 20% by weight, based on the total weight of the components (a), (b), (c) and (e), and coagents are normally used in amounts of from 1 to 50% by weight, based on the total weight of the components (a), (b), (c) and (e).

According to the invention, in the production of the polyurethanes of the invention, vulcanization retarders such as, for example, phthalic anhydride, benzoic anhydride, sulfonamide derivatives or phthalimidesulfenamides (e.g. N-cyclohexylthiophthalimide (CTP)), can also be used.

As chain transfer agents, chain extenders or crosslinkers (e), it is possible to use substances having a molecular weight of from 62 to 400 g/mol, particularly preferably from 62 to 350 g/mol, with chain transfer agents having one hydrogen atom which is reactive toward isocyanates, chain extenders having 2 hydrogen atoms which are reactive toward isocyanates and crosslinkers having 3 hydrogen atoms which are reactive toward isocyanate. These can be used individually or preferably in the form of mixtures. Preference is given to using diamines, diols and/or triols having molecular weights of less than 400, particularly preferably from 62 to 400 and in particular from 62 to 350. Possibilities are, for example, aliphatic, cycloaliphatic and/or araliphatic or aromatic diamines and diols having from 2 to 14, preferably from 2 to 10, carbon atoms, e.g. diethyltoluenediamines (DEDTA), m-phenylenediamine, ethylene glycol, 1,2-propanediol, 2-methyl-1,3-propanediol, 1,3-propanediol, 1,4-butanediol, 1,6-hexanediol, 1,10-decanediol and bis(2-hydroxyethyl)hydroquinone (HQEE), 1,2-, 1,3-, 1,4-dihydroxycyclohexane, bisphenol A bis(hydroxyethyl) ether, diethylene glycol, dipropylene glycol, tripropylene glycol, triols such as 1,2,4-, 1,3,5-trihydroxycyclohexane, glycerol and trimethylolpropane, diethanolamine, triethanolamine and low molecular weight hydroxyl-comprising polyalkylene oxides based on ethylene oxide and/or 1,2-propylene oxide and the abovementioned diols and/or triols as starter molecules. Particular preference is given to using low molecular weight hydroxyl-comprising polyalkylene oxides based on ethylene oxide and/or 1,2-propylene oxide, particularly preferably on ethylene, and trifunctional starters, in particular glycerol and trimethylolpropane, as crosslinkers (e). Particularly preferred chain extenders (e) are ethylene glycol, 1,2-propanediol, 1,3-propanediol, 2-methyl-1,3-propanediol, 1,4-butanediol, diethylene glycol, bis(2-hydroxyethyl)hydroquinone and dipropylene glycol.

If chain extenders and/or crosslinkers (e) are used, the proportion of the chain extenders and/or crosslinkers (e) is usually from 1 to 50, preferably from 2 to 20% by weight, based on the total weight of the components (a), (b), (c) and (e). Preference is given to using no crosslinkers (e).

As chain transfer agent, it is possible to use, for example, 1-octanol. If chain transfer agents are used, they are normally used in an amount of from 0.1 to 5% by weight, based on the total weight of the components (b) to (e).

When the polyurethane of the invention is to be in the form of polyurethane foam, reaction mixtures according to the invention additionally comprise blowing agent (f). Here, it is possible to use all blowing agents known for the production of polyurethanes. These can comprise chemical and/or physical blowing agents. Such blowing agents are described, for example, in “Kunststoffhandbuch, volume 7, Polyurethane”, Carl Hanser Verlag, 3^{rd} edition 1993, chapter 3.4.5. Here, chemical blowing agents are understood to be compounds which form gaseous products by reaction with isocyanate. Examples of such blowing agents are water or carboxylic acids. Here, physical blowing agents are understood to be compounds which are dissolved or emulsified in the starting materials for polyurethane production and vaporize under the conditions of polyurethane formation. These are, for example, hydrocarbons, halogenated hydrocarbons and other compounds, for example perfluorinated alkanes such as perfluorohexane, chlorofluorocarbons, and ethers, esters, ketones, acetals and/or liquid carbon dioxide. Preferred examples of physical blowing agents are propane, n-butane, isobutane and cyclobutane, n-pentane, isopentane and cyclopentane, cyclohexane, dimethyl ether, methyl ethyl ether, methyl butyl ether, methyl formate, tert-butanol, acetone and also fluoroalkanes which can be degraded in the troposphere and therefore do not damage the ozone layer, e.g. trifluoromethane, difluoromethane, 1,1,1,3,3-pentafluorobutane, 1,1,1,3,3-pentafluoropropane, 1,1,1,2,3-pentafluoropropene, 1-chloro-3,3,3-trifluoropropene, 1,1,1,2-tetrafluoroethane, difluoroethane and 1,1,1,2,3,3,3-heptafluoropropane and also perfluoroalkanes such as C₃F₈, C₄F₁₀, C₅F₁₂, C₆F₁₄, and C₇F₁₇. Particular preference is given to hydrocarbons, preferably pentanes, in particular cyclopentane. The physical blowing agents mentioned can be used either alone or in any combinations with one another.

The blowing agent can here be used in any amount. The blowing agent is preferably used in such an amount that the resulting polyurethane foam has a density of from 10 to 850 g/l, particularly preferably from 20 to 800 g/l and in particular from 25 to 500 g/l. Particular preference is given to using blowing agents comprising water. Preference is given to using no blowing agents f).

Auxiliaries and/or additives (g) can optionally also be added to the reaction mixture for producing the polyurethane foams. As auxiliaries and/or additives E, mention may be made by way of example of surface-active substances, foam stabilizers, cell regulators, further mold release agents, fillers, dyes, pigments, hydrolysis inhibitors, flame retardants, odor-absorbing substances, and fungistatic and/or bacteriostatic substances.

Possible surface-active substances are, for example, compounds which serve to aid homogenization of the starting materials and may also be suitable for regulating the cell structure. Mention may be made by way of example of emulsifiers such as the sodium salts of castor oil sulfates or of fatty acids and also salts of fatty acids with amines, e.g. diethylamine oleate, diethanolamine stearate, diethanolamine ricinoleate, salts of sulfonic acids, e.g. alkali metal or ammonium salts of dodecylbenzenesulfonic acid or dinaphthylmethanedisulfonic acid, and ricinoleic acid; foam stabilizers such as siloxane-oxyalkylene copolymers and other organopolysiloxanes, ethoxylated alkylphenols, ethoxylated fatty alcohols, paraffin oils, castor oil esters or ricinoleic esters, Turkey red oil and peanut oil, and cell regulators such as paraffins, fatty alcohols and dimethylpolysiloxanes. Oligomeric acrylates having polyoxyalkylene and fluoroalkane radicals as side groups are also suitable for improving the emulsifying action, the cell structure and/or stabilizing the foam. The surface-active substances are normally used in amounts of from 0.01 to 5 parts by weight, based on 100 parts by weight of the component B and optionally C. Preference is given to using no surface-active substances.

As suitable further mold release agents, mention may be made by way of example of: reaction products of fatty acid esters with polyisocyanates, salts of polysiloxanes comprising amino groups, and fatty acids, salts of saturated or unsaturated (cyclo)aliphatic carboxylic acids having at least 8 carbon atoms and tertiary amines and also, in particular, internal mold release agents such as carboxylic esters and/or carboxylic amides prepared by esterification or amidation of a mixture of montanic acid and at least one aliphatic carboxylic acid having at least 10 carbon atoms with at least bifunctional alkanolamines, polyols and/or polyamines having molecular weights of from 60 to 400 g/mol, as disclosed, for example, in EP 153 639, mixtures of organic amines, metal salts of stearic acid and organic monocarboxylic and/or dicarboxylic acids or anhydrides thereof, as disclosed, for example, in DE-A-3 607 447, or mixtures of an imino compound, the metal salt of a carboxylic acid and optionally a carboxylic acid, as disclosed, for example, in U.S. Pat. No. 4,764,537. Reaction mixtures according to the invention preferably do not comprise any further mold release agents. Particularly when adhesion to rubber is to be produced, preference is given to using no mold release agents.

Fillers, in particular reinforcing fillers, are to be understood as the customary organic and inorganic fillers, reinforcing materials, weighting agents, coating agents, etc., known per se. Specific examples are: inorganic fillers such as siliceous minerals, for example sheet silicates such as antigorite, bentonite, serpentine, hornblends, amphiboles, chrysotile and talc, metal oxides such as kaolin, aluminum oxides, titanium oxides, zinc oxide and iron oxides, metal salts such as chalk and barite, and inorganic pigments such as cadium sulfide, zinc sulfide and also glass, etc. Preference is given to using kaolin (China clay), aluminum silicate and coprecipitates of barium sulfate and aluminum silicate. It is also possible to add inorganic fibers, for example glass fibers. Possible organic fillers are, for example: carbon black, melamine, rosin, cyclopentadienyl resins and graft polymers and also cellulose fibers, polyamide, polyacrylonitrile, polyurethane, polyester fibers based on aromatic and/or aliphatic dicarboxylic esters and in particular carbon fibers.

The inorganic and organic fillers can be used individually or as mixtures and are advantageously added to the reaction mixture in amounts of from 0.5 to 50% by weight, preferably from 1 to 40% by weight, based on the weight of the components A to D. In this case, the filler particles can also be surface-modified in order to prevent agglomeration of the particles. Such modifications are known and are routinely employed in rubber production. In this case, the filler particles, in particular silicate particles, can be surface-modified with physically bound coating agents or with chemically bound coating agents. Physical coatings are described, for example, in EP 341383 and chemical coating, for example with silanols, organosilanes, silicones or chlorosilanes, is described in EP672731. Particular preference is given to silicate which has been surface-modified with bis(triethoxysilylpropyl)tetrasulane.

In the production of the crosslinkable polyurethanes of the invention, the polymeric compounds (b) having at least two groups which are reactive toward isocyanates, any catalysts (c) used, any vulcanizing agents (d) present, any chain extenders and/or crosslinkers (e) used, any blowing agents (f) used and any auxiliaries and/or additives (g) used are usually mixed to give a so-called polyol component and are reacted in this form with the polyisocyanates (a).

As rubber, it is possible to use the rubbers mentioned at the outset. Preferably, butadiene rubber (BR), styrene-butadiene rubber (SBR), isoprene rubber (IR), styrene-isoprene-butadiene rubber (SIBR), acrylonitrile-butadiene rubber (NBR), chloroprene rubber (CR), isobutene-isoprene rubber (IIR), natural rubber (NR), which can be present either in pure form or in blends with one another, are as rubber. Here, the elastomers optionally comprise commercial fillers such as carbon blacks, silica, chalk, metal oxides, plasticizers, antioxidants, ozone stabilizers and/or thermoplastic polymers such as styrene-comprising thermoplastics, for example polystyrene or polystyrene-acrylonitrile (SAN), ethylene-vinyl acetate (EVA), polyethylene, polypropylene, polycarbonate, thermoplastic polyurethane (TPU), polyvinyl chloride (PVC) or thermoplastic elastomers based on styrene-butadiene-styrene block copolymers or styrene-isoprene-styrene block copolymers or blends of the thermoplastics mentioned with one another. Particular preference is given to using polybutadiene, polyisoprene or copolymers of isoprene and butadiene, in particular polybutadiene, as rubber (h). If rubber is present, the proportion of rubber (h) is, based on the total weight of the components a) to h), preferably up to 100% by weight and particularly preferably from 10 to 50% by weight. In a further preferred embodiment of the present invention, the crosslinkable polyurethane does not comprise any rubber (h).

To produce the crosslinkable polyurethanes of the invention, the polyisocyanate prepolymers are mixed with the polymeric compounds having groups which are reactive toward isocyanates, catalysts (c), vulcanizing agents (d), chain extenders and/or crosslinkers (e), blowing agent (f) and any auxiliaries and/or additives (g) used and reacted. Here, the mixing ratios are selected so that the equivalence ratio of NCO groups of the polyisocyanates (a) to the sum of the reactive hydrogen atoms of the components (b) and, if present, (e) and (f) is preferably 0.65-2.0:1, preferably 0.7-1.5:1 and in particular 0.9-1.1:1. A ratio of 1:1 corresponds here to an isocyanate index of 100.

The production of the crosslinkable polyurethanes of the invention is preferably carried out by the one-shot process, for example with the aid of the high-pressure or low-pressure technique. The polyurethanes can be produced in open or closed metallic molds or by continuous application of the reaction mixture to conveyor belts or in tanks.

It is particularly advantageous to employ the so-called two-component process in which, as indicated above, a polyol component is produced and mixed with polyisocyanate a).

The reaction of the components can in principle be carried out under reaction conditions known per se. Particularly if the polyurethane is a thermoplastic polyurethane, the reaction can be carried out batchwise or continuously, for example in a belt process or a reaction extrusion process. Suitable processes are, for example, described in EP 0 922 552 A1 or WO 2006/082183 A1.

In the reaction for producing a thermoplastic polyurethane, for example, the reaction is carried out so that the processing temperature is below 240° C., for example in the range from 100° C. to 220° C., preferably in the range from 110° C. to 190° C., more preferably in the range from 120° C. to 170° C., particularly preferably in the range from 130° C. to 150° C. The reaction is preferably carried out by means of reaction extrusion processes.

It is also possible according to the invention for the process, in particular in the production of a thermoplastic polyurethane, to comprise further steps, for example a pretreatment of the components or an after-treatment of the polyurethane obtained. For example, the thermoplastic polyurethane obtained after the reaction can be heat treated.

Crosslinked polyurethane according to the invention has excellent properties such as a high wet skid resistance, a low rolling resistance, a low abrasion, a high modulus and also good haptic properties. Furthermore, the crosslinked polyurethanes of the invention display excellent mechanical properties such as high elasticity, good recovery, high compressive strength and excellent dimensional stability, even at elevated temperatures, and is therefore suitable for use in the production of tires or tire parts, cable sheathing, seals, shoe soles, rollers or hoses.

In a particularly preferred embodiment, a composite of crosslinked polyurethane and rubber is produced. For this purpose, the crosslinkable polyurethane is applied to rubber or preferably to rubber latex and crosslinked. This can be carried out according to the variants described at the outset. Here, the crosslinkable polyurethane and the rubber are preferably crosslinked simultaneously, preferably using conventional chemical vulcanizing agents. Composite parts according to the invention composed of rubber and crosslinked polyurethane display excellent adhesion values and can be used, for example, as tires or shoe soles. Here, the excellent rubber properties such as wet skid resistance can be combined with the good mechanical properties of polyurethanes, e.g. improved modulus, which makes it possible to obtain, for example, tires having a reduced rolling resistance and excellent grip, particularly in wet conditions.

A further possible way of improving the adhesion between polyurethane and rubber is the use of crosslinkable polyurethane as intermediate layer between rubber or preferably rubber latex comprising vulcanizing agent and conventional polyurethane. Here, a composite body composed of rubber and the crosslinkable polyurethane can be produced in a first step. A molten thermoplastic polyurethane or a reaction mixture for producing a polyurethane is then applied to the crosslinkable polyurethane and is then fully reacted to form the polyurethane. Crosslinking can then be effected by means of suitable conditions during or after production of the composite body, by which means, for example, the adhesion between rubber and polyurethane can be increased.

Blends of crosslinked polyurethane and rubber are likewise obtainable. Here, thermoplastic, crosslinkable polyurethane and rubber are coextruded at temperatures below the temperature which leads to commencement of crosslinking and are subsequently crosslinked. Here, conventional vulcanizing agent is preferably comprised during coextrusion. Such blends according to the invention likewise display excellent mechanical properties such as high elasticity, good recovery, a high compressive strength and excellent dimensional stability, even at elevated temperatures.

It has surprisingly been found that the thermoplastic polyurethanes of the invention or the thermoplastic polyurethanes obtained by a process according to the invention are well-suited to the production of foamed materials. Here, the thermoplastic polyurethanes of the invention can be processed in a manner known per se to give foamed materials. Additives such as blowing agents, cell regulators, surface-active substances, nucleating agents, fillers, hollow microspheres and/or mold release agents are optionally used here. Suitable processes and additives are disclosed, for example, in WO2014/198779 A1, in WO 2007/082838 A1 or in WO 94/20568 A1.

The present invention thus also provides, according to a further aspect, for the use of a thermoplastic polyurethane as described above or a thermoplastic polyurethane obtainable or obtained by moldings of foam particles and also the particle foams obtainable therefrom, with the foamed films, foamed moldings or foam particles and particle foams obtainable therefrom being reinforced with fillers.

The advantages of the present invention are illustrated below with the aid of examples:

### 1. PRODUCTION EXAMPLE

The following starting materials were used:
Polyol 1: polybutadiene polyol prepared by means of anionic polymerization and having a functionality of 1.9, with exclusively primary OH groups and an OH number of 53.8
Polyol 2: polybutadiene polyol prepared by means of free-radical polymerization and having a functionality of 2.4, with exclusively primary OH groups and an OH number of 52.5
Polyol 3: polyol prepared from polyol 1, capped with 30% by weight of polycaprolactone
Polyol 4: polyol prepared from polyol 2, capped with 30% by weight of polycaprolactone
Polyol 5: polyether polyol having an OH number of 55.8 and exclusively primary OH groups (based on tetramethylene oxide, functionality: 2)
Isocyanate 1: aromatic isocyanate (diphenylmethane 4,4′-diisocyanate)
Isocyanate 2: mixture of aromatic isocyanate prepolymer based on MDI and polypropylene glycol and carbodiimide-modified MDI, NCO content approx. 26% by weight
Chain extender 1 (KV 1): 1,4-butanediol
Chain extender 2 (KV 2): 1,5-pentanediol
Chain extender 3 (KV 3): 1,6-hexanediol
Chain extender 4 (KV 4): glycerol
Chain transfer agent 1 (KR 1): 1-octanol
Antifoam: Xiameter antifoam from Dow Corning
Catalyst: metal catalyst
Rubber 1: natural rubber (Neorub 340 P®, commercially available from Weber & Schaer)
Rubber 2: nitrile-butadiene rubber (Perbunan NT 3445, commercially available from Lanxess)
Rubber 3: styrene-butadiene rubber (Buna® SBR 1500, commercially available from Trinseo)
Filler 1: precipitated silica modified with sulfur-comprising organosilane
Additive 1: sterically hindered phenol
Additive 2: sterically hindered phenol
Vulcanizing composition 1 (VZ1): sulfur
Vulcanizing composition 2 (VZ2): N-cyclohexyl-2-benzothiazylsulfenamide (80%)
Vulcanizing composition 3 (VZ3): zinc oxide
Rubber formulation 1 (KF1): typical rubber formulation based on styrene-butadiene rubber, natural rubber, carbon black, silicates, sulfur-comprising organosilanes, VZ1, VZ2, VZ3

ε-Caprolactone was dried over CaH₂ and subsequently distilled at 130° C. under reduced pressure, stored at −30° C. under argon and used within 14 days. Titanium tetrabutoxide was dissolved in dry toluene to give a 50% strength by volume solution and the solution was stored under argon.

### Preparation of Polyol 3

2733 g (1.242 mol) of polyol 1 were dried for three hours at 100° C. under reduced pressure in a 5 l steel reactor and 1179 g (10.35 mol) of distilled ε-caprolactone were added under nitrogen. The components were homogeneously mixed by stirring at 250 rpm and 120° C., before 430 l of a titanium tetrabutoxide solution (15 ppm of titanium, 50% by volume in toluene) was added and the reactor was closed. After stirring for 4 hours at 120° C., the product was drained.

### Preparation of Polyol 4

1367 g (506.4 mmol) of polyol 2 were dried for three hours at 100° C. under reduced pressure in a 5 l steel reactor and 462.7 g (4.059 mol) of distilled ε-caprolactone were added under nitrogen. The components were homogeneously mixed by stirring at 250 rpm and 150° C., before 840 μl of titanium tetrabutoxide solution (15 ppm of titanium, 10% by volume in toluene) was added and the reactor was closed. After stirring for 4 hours at 150° C., the product was drained.

### Determination of the Hydroxyl Number (OH Number)

The hydroxyl number of the polyols 3 and 4 (OH number) was determined in accordance with DIN 53240 2 and is shown in Table 1. The slightly different values for the OH number for polyols result from different reaction batches of polyol 1 or 2 with ε-caprolactone.

### Example of TPU Synthesis:

A thermoplastic polyurethane was synthesized from diphenylmethane 4,4-diisocyanate, chain extender 1,6-hexanediol with a polycaprolactone-capped polybutadienediol corresponding to the data in Table 1 by stirring in a reaction vessel. After a reaction temperature of 80° C. had been reached, the solution was poured onto a heated hot plate at 125° C. and the TPU plate obtained was granulated after heat treatment (80° C., 15 hours).

The combination of polyols 3 and 5 enable the TPU to be poured out at a higher temperature. In the case of TPU 8, the temperature was 110° C. during casting. The granular material was processed further either on a calender or kneader or subsequently processed further by injection molding to give test specimens.

### Formulations

TABLE 1
Synthesis examples

| | TPU comparison 1 | TPU comparison 2 | TPU 1 | TPU 2 | TPU 3 | TPU 4 | TPU 5 | TPU 6 | TPU 7 |
|---|---|---|---|---|---|---|---|---|---|
| OH | 53.70 | 53.70 | 34.20 | polyol | 34.20 | 34.80 | 33.60 | 33.60 | polyol |
| number | | | | 3: 34.20, | | | | | 3: 33.65, |
| of the | | | | polyol | | | | | polyol |
| polyol | | | | 4: 37.78 | | | | | 5: 56.00 |
| Polyol | 1000.0 | 1000.0 | | | | | | | |
| 1 [g] | | | | | | | | | |
| Polyol | | | 1000.0 | 833.3 | 1000.0 | 1000.0 | 1086.3 | 1049.5 | 600.0 |
| 3 [g] | | | | | | | | | |
| Polyol | | | | 166.7 | | | | | |
| 4 [g] | | | | | | | | | |
| Polyol | | | | | | | | | 400.0 |
| 5 [g] | | | | | | | | | |
| Isocyanate 1 | 204.3 | 209.3 | 157.5 | 158.9 | 162.5 | 261.5 | 309.8 | 350.1 | 211.5 |
| [g] | | | | | | | | | |
| KV 1 | | | | | | | | 92.0 | |
| [g] | | | | | | | | | |
| KV 2 | | | | | | | 95.2 | | |
| [g] | | | | | | | | | |
| KV 3 | 39.9 | 39.6 | 38.4 | 38.4 | 38.0 | 82.3 | | | 55.0 |
| [g] | | | | | | | | | |
| KV 4 | | 0.2 | | | 0.2 | | | | |
| [g] | | | | | | | | | |
| KR 1 | | 1.0 | | | 1.0 | | | | |
| [g] | | | | | | | | | |
| Additive 1 | | 8.00 | | | 8.00 | 8.00 | 8.69 | 8.39 | 6.40 |
| [g] | | | | | | | | | |
| Additive 2 | | | | | | | | | 6.40 |
| [g] | | | | | | | | | |
| Index | 100 | 100 | 100 | 100 | 100 | 100 | 100 | 100 | 100 |
| Melting | 40 to 60° C. | 40 to 60° C. | >100° C. | >100° C. | >100° C. | >100° C. | >100° C. | >100° C. | >100° C. |
| point* | | | | | | | | | |
| [° C.] | | | | | | | | | |

*The melting behavior was evaluated on a calender. The TPU comparisons 1 and 2 based on polyol 1 melted at very low temperatures, which indicates a very low molecular weight. The material adhered so strongly to the metallic surface of the calender that no rolled sheet could be obtained. In contrast, the TPUs based on polyol 3 displayed a higher melting point and rolled sheets could be obtained. Owing to the incompatibility of the monomers, no satisfactorily high molecular weight was obtained in Comparative Examples 1 and 2. Furthermore, 5 parts by weight of the TPUs 1 to 7 were dissolved in 95% by weight of DMF. Visual inspection of the solutions indicated that the polymer had dissolved completely.

### Crosslinking by Means of Dicumyl Peroxide

As indicated in table 3, the starting materials for the polyol component were heated and mixed at 50° C. for about 30 minutes, dicumyl peroxide was subsequently added to the polyol component in the examples according to the invention and was mixed with the isocyanate for 1 minute. The mixture was poured into a step mold which had depths of 2, 6 and 10 mm and was heated to 50° C. and struck flat by means of a plastic bar. After 30 minutes, the elastomer which was already solid was removed from the mold. After storage at room temperature for about 18 hours, the plate was stored at 160° C. for 30 minutes. The plate was subsequently heated at 80° C. for another 2 hours. Before characterization, the polyurethane elastomer was stored at 23° C. at 50% atmospheric humidity for at least 7 days.

| | Comp. | Ex. | Ex. | Comp. | Ex. | Ex. |
|---|---|---|---|---|---|---|
| | 1 | 1 | 2 | 2 | 3 | 4 |
| Cat [g] | 0.15 | 0.15 | 0.15 | 0.15 | 0.15 | 0.15 |
| Antifoam [g] | 0.3 | 0.3 | 0.3 | 0.3 | 0.3 | 0.3 |
| KV1 [g] | 4.0 | 4.0 | 4.0 | 4.0 | 4.0 | 4.0 |
| Polyol 3 [g] | 95 | 95 | 95 | | | |
| Polyol 4 [g] | | | | 95 | 95 | 95 |
| Dicumyl | | 0.2 | 0.3 | | 0.2 | 1.0 |
| peroxide | | | | | | |
| [g] | | | | | | |
| Iso 2 | x | x | x | x | x | x |
| Index | 100 | 100 | 100 | 100 | 100 | 100 |
| Shore A | 69 | 71 | 70 | 69 | 68 | 78 |
| Tensile | 10 | 10 | 11 | 6 | 5 | 6 |
| strength | | | | | | |
| Elongation at | 380 | 170 | 130 | 220 | 140 | 70 |
| break | | | | | | |
| CS (24 h/ | 54 | 30 | 21 | 25 | 17 | 17 |
| 70° C./ | | | | | | |
| 30 min) [%] | | | | | | |
| CS (24 h/ | 98 | 55 | 41 | 57 | 45 | 25 |
| 70° C./ | | | | | | |
| 30 min) [%] | | | | | | |

Table 3 shows, compared to purely thermal crosslinking as per the comparative examples, a significantly improved compression set at similar hardness and tensile strength and also a lower elongation at break due to the crosslinking for crosslinking carried out using peroxide.

### Examples of Blends of Rubber and TPU

### Production

The respective TPU together with the rubber corresponding to the composition from Table 3 was mixed in a 200 g laboratory kneader at 180° C. and 50 revolutions per minute for 10 minutes. The blends were subsequently stored at room temperature for at least 24 hours.

### Formulations

TABLE 3
Examples of synthesis of the blends

| | Blend 1 | Blend 2 | Blend 3 | Blend 4 | Blend 5 |
|---|---|---|---|---|---|
| TPU | TPU 4 | TPU 5 | TPU 5 | TPU 5 | TPU 6 |
| Rubber 1 | 30% | 25% | | | 50% |
| Rubber 2 | | | 33% | | |
| Rubber 3 | | | | 33% | |

### Example of TPV or TPV-Rubber Blend Synthesis

### Production Example on a Laboratory Roll Mill

The TPU 3 was rolled out at 130° C. on a laboratory roll mill to give a mat. The vulcanizing additives corresponding to the data in Table 4 (ex. 7) were subsequently added. The roll sheet obtained was subsequently stored at room temperature for from 3 to 12 hours.

### Vulcanization

In a steam-heated vulcanization press, the TPV or TPV/rubber is placed in a 15 cm×15 cm steel frame having a thickness of from 1.8 to 2 mm and vulcanized at 100 bar, 150 to 170° C. for from 10 to 25 minutes according to the vulcanization behavior determined by means of a vulcameter.

### Examples of Vulcanization Conditions

TABLE 4
Vulcanization conditions for producing TPV

| | Comp. 3 | Com. 4 | Comp. 5 | Ex. 5 | Ex. 6 | Ex. 7 | Ex. 8 | Ex. 9 |
|---|---|---|---|---|---|---|---|---|
| TPU/blend | Comparison 1 | Comparison 2 | Comparison 2 | TPU 1 | TPU 2 | TPU 3 | TPU 3 | TPU 7 |
| VZ 1 [phr] | 2 | 2 | 2 | 2 | 2 | 2 | 2 | 2 |
| VZ 2 [phr] | 1 | 1 | 1 | 1 | 1 | 1 | 1 | 1 |
| VZ 3 [phr] | 2 | 2 | 2 | 2 | 2 | 2 | 2 | 2 |
| Filler 1 | 0 | 0 | 2 | 0 | 0 | 0 | 2 | 0 |
| [phr] | | | | | | | | |
| Pressure | 100 | 100 | 100 | 100 | 100 | 100 | 100 | 100 |
| [bar] | | | | | | | | |
| Temperature | 170 | 170 | 170 | 170 | 170 | 170 | 170 | 170 |
| [° C.] | | | | | | | | |
| Time | 25 | 25 | 25 | 25 | 25 | 25 | 25 | 25 |
| [min.] | | | | | | | | |

TABLE 5
Vulcanization conditions for the production of TPV/rubber blends

| | Ex. 10 | Ex. 11 | Ex. 12 | Ex. 13 | Ex. 14 |
|---|---|---|---|---|---|
| TPU/blend | Blend 1 | Blend 3 | Blend 4 | Blend 5 | Blend 2 |
| VZ 1 [phr] | 2 | 2 | 2 | 2 | 2 |
| VZ 2 [phr] | 1 | 1 | 1 | 1 | 1 |
| VZ 3 [phr] | 2 | 2 | 2 | 2 | 2 |
| Pressure [bar] | 100 | 100 | 100 | 100 | 100 |
| Temperature [° C.] | 170 | 170 | 170 | 150 | 170 |
| Time [min.] | 25 | 25 | 25 | 30 | 25 |

### Examples of Mechanical Properties

TABLE 6
Examples of properties of the vulcanizates

| | Ex. 5 | Ex. 6 | Ex. 7 | Ex. 8 | Ex. 9 | Ex. 10 | Ex. 11 | Ex. 12 | Ex. 13 | Ex. 14 |
|---|---|---|---|---|---|---|---|---|---|---|
| | TPU 1 | TPU 2 | TPU 3 | TPU 3 | TPU 5 | Blend 1 | Blend 3 | Blend 4 | Blend 5 | Blend 2 |
| Density | 1.033 | 1.029 | 1.033 | 1.035 | 1.054 | 1.035 | 1.044 | 1.030 | 1.002 | 1.042 |
| [g/cm3] | | | | | | | | | | |
| Shore A | 61 | 60 | 67 | 69 | 66 | 66 | 69 | 64 | 57 | 67 |
| Tensile | 7 | 6 | 7 | 9 | 10 | 10 | 11 | 7 | 16 | 10 |
| strength | | | | | | | | | | |
| [MPa] | | | | | | | | | | |
| Elongation at | 400 | 360 | 340 | 350 | 500 | 420 | 380 | 330 | 540 | 400 |
| break [%] | | | | | | | | | | |
| Tear | 13 | 12 | 14 | 12 | 15 | 15 | 13 | 16 | 11 | 15 |
| propagation | | | | | | | | | | |
| resistance | | | | | | | | | | |
| [kN/m] | | | | | | | | | | |
| E modulus | 5 | 6 | 4 | 6 | 5 | | 6 | 4 | | 7 |
| [MPa] | | | | | | | | | | |
| TMA Onset | 210 | 219 | 227 | 214 | 221 | 197 | 398 | 425 | 208 | 224 |
| temperature | | | | | | | | | | |
| [° C.] | | | | | | | | | | |

* In the case of comparative examples 1, 2 and 3, there was very severe bubble formation during vulcanization. As a result, no mechanical properties of the plates could be measured.

### Example for TPV/Rubber Composites

On a laboratory roll mill, the TPU or the TPU/rubber blend was admixed at from 80 to 130° C. with the vulcanization accelerator system according to the data in Tables 4 to 9 and rolled out to give 3-4 mm thick mats.

Firstly the rubber formulation (KF1) with the vulcanization additives and subsequently the TPU formulation were placed in a stainless steel frame (dimensions 7×13×19 mm), so that the material to be pressed was at least 1 mm thicker than the stainless steel frame. A 2 cm wide strip of Mylar film was placed between the rubber formulation and TPU formulation at the periphery to enable the clamps for the peel-off test to be fastened later in this region.

TABLE 7
Examples of the production of TPV or TPV/rubber on rubber

| | | | |
|---|---|---|---|
| Com. 3 | Com. 4 | Com. 5 | Com. 6 |

Additives in the TPU

| | | | | |
|---|---|---|---|---|
| TPU [phr] | 100 of | 100 of | 100 of | 100 of |
| | TPU 3 | TPU 3 | TPU 7 | blend 2 |
| VZ 1 [phr] | 2 | 2 | 2 | 2 |
| VZ 2 [phr] | 1 | 1 | 1 | 1 |
| VZ 3 [phr] | 2 | 2 | 2 | 2 |
| Filler 1 [phr] | 0 | 2 | 0 | 2 |

Rubber formulation used

| | | | |
|---|---|---|---|
| KF1 | KF1 | KF1 | KF1 |

Vulcanization conditions

| | | | | |
|---|---|---|---|---|
| Presssure [bar] | 100 | 100 | 100 | 100 |
| Temperature [° C.] | 170 | 170 | 170 | 170 |
| Time [min.] | 25 | 25 | 25 | 25 |

### Determination of the Adhesion

The two individual layers, consisting of PU and rubber, were vulcanized over the entire length of their flat side in a press (corresponds to the test plate). 2 cm Mylar film was placed between the two layers along the longitudinal side so that the specimens part at the place where they are later to be pulled by the machine. The test plate is sawn into 20 mm wide pieces to give a total of 5 test specimens.

The lower tensioning chuck is firstly disassembled so that the strain gauge can be removed from the test section (direction lower traverse). The roller bearing is then clamped in the upper tensioning chuck and the lower tensioning chuck is reassembled with clamp.

The test specimen is placed on the rollers and a layer (preferably the rubber layer) is pulled on the side of the Mylar film by means of a pincette through the two rollers and fixed in the lower clamp. The tensioning chuck then moves down and pulls the one layer from the other.

The maximum force Fₘₐₓ in N and the strain in mm to rupture are reported as means from 5 tests.

The results of the 90° C. peel-off test are listed in Table 11. The bottom line shows the maximum force which the machine was able to measure without rupture occurring at the phase boundary or in one of the two materials.

TABLE 8
Examples for adhesion (90° C. peel-off test)

| | Com. 3 | Com. 4 | Com. 5 | Com. 6 |
|---|---|---|---|---|
| Force maximum at | | | | |
| rupture at the phase | | | | |
| boundary [N] | | | | |
| Force maximum at | | | 367 | 364 |
| failure of the material [N] | | | | |
| Force maximum with | 449 | 469 | | |
| no failure of the | | | | |
| material [N] | | | | |

### Measurement Methods:

The following measurement methods, inter alia, can be utilized for the characterization of the materials: DSC, DMA, TMA, NMR, FT-IR, GPC.

| | |
|---|---|
| Shore hardness A | DIN 7619-1, |
| Tensile strength | DIN 53 504, |
| Elongation at break | DIN 53 504, |
| Tear propagation resistance | DIN 53 515, |
| Compression set (CS) | DIN ISO 815, |
| E modulus | DIN 53 504 (S1 tensile bar), |
| Abrasion | DIN 4649 |

1. A crosslinked polyurethane obtainable by a process wherein
a) polyisocyanates are mixed with
b) polymeric compounds having on average at least 1.5 hydrogen atoms which are reactive toward isocyanate groups and comprising
b1) at least one diene block copolymer which has on average at least 1.5 hydrogen atoms which are reactive toward isocyanate and has a polydiene main chain and at least one side chain or terminal chain composed of a polyether and/or a polyester, where the proportion by weight of the polydiene main chain is, based on a total weight of the diene block copolymer b1), from 25 to 95% by weight and
b2) optionally further polymeric compounds having at least two hydrogen atoms which are reactive toward isocyanate,
c) optionally catalyst,
d) vulcanizing agents,
e) optionally chain extenders, chain transfer agents and/or crosslinkers,
f) optionally blowing agent and
g) optionally auxiliaries and/or additives,
h) optionally rubber
to give a reaction mixture and the mixture is cured to give crosslinkable polyurethane and double bonds of the diene block copolymer b1) are crosslinked, wherein the crosslinking of the double bonds of the diene block copolymer b1) is effected by means of a sulfur-comprising vulcanizing agent or by means of a peroxide-comprising vulcanizing agent (d).

2. The crosslinked polyurethane according to claim 1, wherein the crosslinking of the double bonds of the diene block copolymer b1) is effected by means of a sulfur-comprising vulcanizing agent or by means of a peroxide-comprising vulcanizing agent and the vulcanizing agent is added only after production of the polyurethane.

3. The crosslinked polyurethane according to claim 1, wherein symmetric diisocyanates are used as polyisocyanates.

4. The crosslinked polyurethane according to claim 1, wherein a reaction product of polybutadienol and a cyclic ester is used as diene block copolymer b1) having at least two hydrogen atoms which are reactive toward isocyanate.

5. The crosslinked polyurethane according to claim 1, wherein the diene block copolymer b1) having at least two hydrogen atoms which are reactive toward isocyanate has a number average molecular weight of from 500 to 20 000 g/mol and an average OH functionality of from 1.8 to 5.0.

6. The crosslinked polyurethane according to claim 1, wherein the diene block copolymer b1) having at least two hydrogen atoms which are reactive toward isocyanate has at least 50% of primary OH groups, based on a content of OH groups in the diene block copolymer.

7. The crosslinked polyurethane according to claim 1, wherein chain extender and/or crosslinker e) is selected from the group consisting of ethylene glycol, 1,2-propanediol, 1,3-propanediol, 2-methyl-1,3-propanediol, 1,4-butanediol, 1,5-pentanediol, 1,6-hexanediol, diethylene glycol, glycerol, trimethlyolpropane, ethoxylated and/or propoxylated glycerol, ethoxylated and/or propoxylated trimethylolpropane, dipropylene glycol, bis(2-hydroxyethyl)hydroquinone and mixtures of two or more components from among these.

8. The crosslinked polyurethane according to claim 1, wherein the auxiliaries and additives g) comprise silicates which can be surface-modified.

9. The crosslinked polyurethane according to claim 1, wherein the production of the polyurethane is carried out at an isocyanate index of from 90 to 110.

10. A composite comprising a crosslinked polyurethane according to claim 1 and rubber.

11. A blend of a crosslinked polyurethane according to claim 1 and rubber.

12. A process for producing a composite according to claim 10, wherein crosslinkable polyurethane and rubber are brought into contact and crosslinked.

13. A method of using the crosslinked polyurethane according to claim 1, the method comprising using said crosslinked polyurethanes for producing tires or parts of tires, cable sheathing, shoe sole, roller or hose.

14. A method of using the crosslinked polyurethane according to claim 1, the method comprising using said crosslinked polyurethanes for producing foamed films, foamed moldings or foamed particles and the particle foams obtainable therefrom.
